(19) United States
(12) Patent Application Publication
(10) Pub. No.: US 2005/0179702 A1
(43) Pub. Date: Aug. 18, 2005

(54) Embedded video processing system

(75) Inventors: David R. Tomlinson, Santa Monica, CA (US); David Tweed, Lowell, MA (US)

Correspondence Address: GREENBLUM & BERNSTEIN, P.L.C., 1950 ROLAND CLARKE PLACE, RESTON, VA, 20191, US

(73) Assignee: Video Delta, Inc., Santa Monica, CA (US)

(21) Appl. No.: 10/777,158

(22) Filed: Feb. 13, 2004

(51) Int. Cl. G09G 5/00

(52) U.S. Cl. 345/629

(57) ABSTRACT

A real time embedded video processing system includes a central processing unit (CPU); a real time operating system; and an input/output interface that receives user input via a user input device. The system runs a graphics application that generates computer graphics in response to user input. A device control application controls multiple different video input sources in response to user input. The system includes a video processing engine comprising a dedicated logic circuit, such as a field programmable gate array (FPGA). The circuit includes a pixel processing engine that receives input from at least one of the video input sources and receives computer graphics from the graphics application. The pixel processing engine alpha blends the computer graphics with the video input and then outputs the blended data in real time.

### BACKGROUND OF THE INVENTION

1. Field of the Invention

The present invention relates to the fields of computer graphics, device control and video processing. More particularly, the present invention relates to blending user generated computer graphics with a video stream controlled by a user and selecting between and controlling multiple video input sources.

2. Background Information

It is known that most all video playback devices including video tape decks, video camcorders, DVD players, laserdiscs, and computer based digital video workstations can play back video and be controlled by remote control. Remote control is achieved with either wired or wireless devices utilizing such protocols as Sony Serial Protocol, RS-422, RS-232C, Sony Control L, Panasonic Control M, and Infrared.

Some widely adopted remote controls have a built in laser pointer for directing attention to specifics in the video. A need exists, however, for the ability to draw on the video with a device similar in nature and function to the laser pointer. Systems already exist for drawing graphics over video, however they typically use a touch screen monitor or graphics tablet for user input and have other limitations, such as size and cost, making them unsuitable for many uses.

A wireless remote control device equipped with an electronic gyroscope is available from Gyration, Inc. of Saratoga, Calif. The remote enables a user to move a computer cursor on a screen by moving the remote around in the air.

### SUMMARY OF THE INVENTION

The present invention relates to a system and method for drawing and generating graphics over video (“telestration”), video switching, video multiplexing, and for device control. In view of the above, the present invention through one or more of its various aspects and/or embodiments is presented to accomplish one or more objectives and advantages, such as those noted below.

In one aspect, a real time embedded video processing system includes a real time operating system, and a graphics application that generates computer graphics in response to user input. The system also includes an input control application that controls at least one video input source in response to user input; and a video processing engine. The engine receives input from at least one of the video input sources and receives computer graphics from the graphics application. The video processing engine blends the computer graphics with the input and outputs the blended data in substantially real time. The blended data may be stored as an image file. The video processing engine may output the blended data to multiple output devices. The system may be portable.

An input/output (I/O) interface that communicates with a user input device may also be provided. The I/O interface can communicate with a mass storage device. In one embodiment, the video processing engine receives input from the mass storage device and overlays the computer graphics on the input received from the mass storage device in real time. The I/O interface may be a USB interface.

In one embodiment, the video processing engine is a dedicated logic circuit, at least one encoder, at least one video decoder, and a video buffer. The video input sources may have different control protocols, for example RS-232, RS-422, Control-M, LANC, and infrared.

The video input sources can generate video streams having different formats, including YUV, RGB, S-Video, composite, VGA, and DVI. In one embodiment, the system translates video from one of the formats to another of the formats. For example, one of the video streams can be in a YUV format, and the video processing engine digitally color maps the YUV format into an RGB format.

In one embodiment, the user input device is a PDA comprising a client application that communicates with a host application within the system.

A dedicated logic circuit for real time video processing, may include a pixel processing engine that receives input from a video input source and receives computer graphics from a graphics application, the pixel processing engine alpha blending the computer graphics with the video input source and outputting the blended data in substantially real time. The dedicated logic circuit may also include a buffer controller that controls an external buffer, and a CPU interface that receives the computer graphics. The dedicated logic circuit may process multiple input video streams and output multiple output video streams, the streams having a plurality of different formats.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawings, and in which:

FIG. 1 is an exemplary block diagram of the system, according to an aspect of the present invention;

FIG. 2 is a functional block diagram showing elements of the embedded video processing system, according to an aspect of the present invention;

FIG. 3 is a block diagram showing a dedicated logic circuit, according to an aspect of the present invention; and

FIG. 4 is a block diagram showing the pixel processing engine of the dedicated logic circuit in more detail, according to an aspect of the present invention.

### DETAILED DESCRIPTION

The present invention is designed to fit the needs of a wide array of users, including anyone who lectures with the aid of video and wishes to add graphics to the video to improve understanding of the information. The general concept is to provide remote control, video switching, and drawing capabilities with the freedom to be in front of an audience, untethered by wires or non-portable input devices. A unique way to annotate live video signals in order to enhance presentations is thus provided. Moreover, a stand-alone embedded video processing computer running a real time operating system avoids the problems of the standard PC, such as lack of portability, heat issues, moving parts (e.g., hard drives) susceptible to failure, long boot up times, operating system hangs, etc.

According to an aspect of the present invention, the stand-alone embedded video processing computer receives incoming analog video signals. The signals can be in any format. In one embodiment, The signals may be in YUV, RGB, S-Video, Composite, and VGA formats, and digital video in the DVI (Digital Visual Interface) format. One of the multiple incoming video signals can be selected for processing and output, thus providing a video switching functionality. After the video is processed, the stand-alone embedded video processing computer outputs analog video in one of a variety of formats. In one embodiment, the formats include YUV, RGB, S-Video, Composite, and VGA formats, and digital video in the DVI (Digital Visual Interface) format. Preferably, the NTSC, PAL and SECAM broadcast standards are also supported.

In another aspect of the present invention, the embedded video processing system enables device control using multiple formats, such as RS-422, RS-232, Control-M, LANC, USB, and infrared (IR). The system has the ability to control more than one device with different control protocol requirements with a common remote control.

The video processing system includes graphics software that enables a user to create a variety of real time drawings and/or graphics using an input device such as the Gyration Remote as well as other input devices such as a standard graphics tablets or a mouse. The embedded video processing computer combines the graphics with incoming video. In an embodiment, the system is compatible with flash media formats. Thus, the system can import graphics files, such as jpegs, bitmaps, tiffs, etc. from portable flash media for display and telestration.

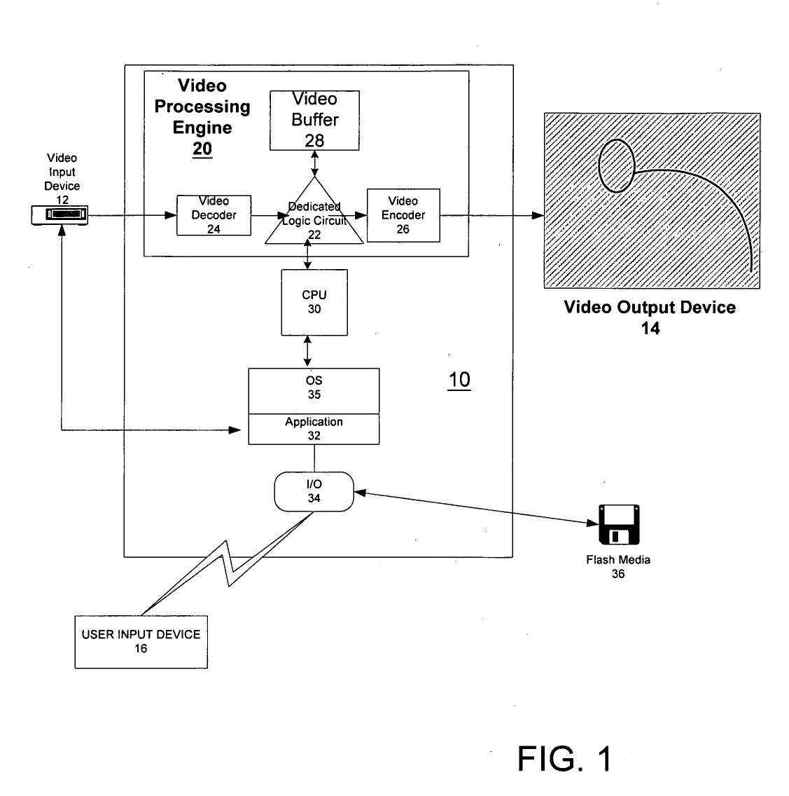

Referring now to FIG. 1, a general description of the overall system will be provided.

The embedded device 10 is connected to video input sources 12, such as a VCRs, digital video workstations, etc. A wide variety of video input types are supported and multiple video sources 12 can be simultaneously connected to the video processing device 10. The embedded system 10 is also connected to a video output device(s) 14, which displays the output. User input is supplied by a user input device 16. The user input device 16 controls the input sources 10 and also enables the user to generate graphics.

Preferably the device 10 is portable. In one embodiment, the device weighs five pounds and is approximately fourteen inches wide, six inches deep, and three inches tall.

Within the embedded video processing computer 10 resides a video processing engine 20. The engine 20 includes a dedicated logic circuit 22, such as a field programmable gate array (FPGA), that executes all real time video processing, video buffering, interfacing with a CPU 30, receiving computer graphics created by the user, and blending computer graphics with video. The engine 20 also includes a decoder 24 for decoding (i.e., digitizing) video into a digital format and an encoder 26 for encoding video back into analog video. The decoders 24 and encoders 26 are controlled by the dedicated logic circuit 22. Finally, a video buffer 28 is provided for storing images and graphics.

Although FIG. 1 shows a single video decoder 24, multiple decoders can be provided. In one embodiment, there are two separate input decoders 24: one that handles all of the broadcast standards (NTSC, PAL and SECAM) and another that handles high-resolution and digital formats (VGA, DVI and HDTV). A video encoder 26 encodes the video into an appropriate format before outputting it to the video output device 14. Similarly, multiple encoders 26 can be provided, e.g., three output encoders, to handle all of these formats, including one that handles all of the broadcast standards (NTSC, PAL and SECAM), another that handles high-resolution and digital formats (DVI and HDTV), and a digital to analog converter (DAC) for VGA.

The video processing engine 20 communicates with a central processing unit 30. The CPU 30 may be an Intel PXA255 Processor with Intel XScale Technology, available from Intel Corporation of Santa Clara, Calif. Preferably, the CPU 30 executes the ARM instruction set (including the Thumb variation) at internal speeds up to 400 MHZ. The processor 30 preferably has a large set of on-chip peripheral controllers used to control the devices in the hardware video path: the broadcast video decoder; the DVI/VGA decoder, the broadcast video encoder, the DVI encoder, and the digital to analog converter. In one embodiment, the dedicated logic circuit controls the decoder-encoder chips,. In another embodiment, the Xscale chip has onboard UARTs providing RS-232 p and RS-422 communication ports.

A software application 32 interoperates with a real time operating system 35, such as Windows CE, available from Microsoft Corporation of Redmond Wash. The application 32 receives user input via an input/output port 34, e.g., a USB port, from a user input device 16. In a preferred embodiment, the user input is sent via RF to the port 34 from the input device 16.

In addition to using video from the video input devices 12, graphics files, such as jpegs and bitmaps, can be opened from flash media 36 and used as a video source for telestration. In order to use data from flash media, the flash media 36 communicates with the video processing device 10 via the I/O port 34.

Two types of user input are germane to the present invention: video input device control, and graphics generation. For device control, some of the buttons on the input device 16 are assigned to functions for remote control of the video input sources 12. The application 32 translates each command into appropriate deck control protocols (a wide variety of control protocols are supported) and forwards the command to the appropriate video input source 12 via communication ports of the video processing device 10. The video processing device 10 can control video playback sources 12 via hardwired interfaces or an infrared (IR) transmitter. In addition, using the input device 16, the user can switch to a different video input source 12 and control the selected video input source 12 with the same user input device 16.

Other functions of the input device 16 result in graphics being created by the user. These graphics are passed through to the dedicated logic circuit 22 and the user is able to see the results in real time.

Multiple types of user input devices 16 are contemplated. For example, a wireless remote control, such the GyroRemote available from Gyration, Inc., can be used. Standard USB mice and graphics tablets can also be used. In alternate embodiments, a PDA (Personal Digital Assistant) is used.

The GyroRemote is a wireless RF remote that can move a computer cursor by moving the remote physically in the air. The remote functions similarly to a mouse. It has several extra buttons that can be utilized as remote control buttons for an external video device.

Traditional graphics tablets do not offer the mobility of the Gyro Remote or a PDA however a graphics tablet can be supported and connected to the USB port 34.

The PDA is another supported input device. It communicates to the base unit 10 via e.g., 802.11 or Bluetooth wireless Ethernet. Client software is installed on the PDA and provides the interface. In this case, the client software communicates with server software running on the main unit 10. Telestration is achieved by drawing with the stylus. Device control is achieved either by icons on the PDA screen or with PDA keys if available, such as on the Handspring Treo 90, available from palmOne, Inc. of Milpitas, Calif. Depending on PDA resources, still pictures displayed on the monitors 14 could be transmitted to the PDA screen for telestration purposes. The PDA 16 can be enabled by installing a IEEE 802.11b wireless Ethernet SDIO card in both the main unit 10 and the PDA 16, or by using a wireless Ethernet to USB hub in the unit 10 and an SDIO card in the PDA 16.

As noted above, the video processing device 10 of the present invention accepts video in a number of international standard analog formats, as well as digital video (via DVI) and VGA signals from computers. The device 10 produces analog video in all of the same international standard analog formats as well as digital video (via DVI) and VGA signals for computer displays. Also the ability to translate between the various video formats, e.g. YUV to SVideo, is provided. Moreover, multiple output formats based upon a single input stream can be provided.

The video processing device 10 includes connectors for video input and for video output, connectors for video transport control, an interface 34 to the user input device 16, and infrared transport control outputs. In one embodiment, the video inputs include six BNC connectors, five connectors for component video and sync and one connector for composite video, along with an RCA connector that is a second composite video input. Also provided are a dual USB host connector, two Y/C (S-video) input connectors, a DVI input connector and a VGA input connector.

Exemplary transport control includes connectors for one 9-pin RS-422, one 9-pin RS-232C, one Control-M 5-pin DIN, one LANC 5-pin DIN, one USB device, and Infrared included both an Infrared transmitter mounted directly on the front of the base unit and a wired IR transmitter pendant that can be attached to the face of the IR receiver.

Video output connections include six BNC connectors for video out—five for component video and one for composite video, a DVI connector, a VGA connector, and a 4-pin DIN Y/C (S-video) output connector.

In one embodiment, the analog video inputs are processed by a Philips SAA7118E multi standard video decoder. VGA video and DVI digital video input may be processed by an Analog Devices AD9882 decoder.

The analog video outputs may be processed by a Philips SAA7129H multi standard video encoder. VGA output is processed by an Analog Devices ADV7125 digital to analog converter. DVI output is processed by a Chrontel CH7010A encoder.

Video transport control outputs can be in many formats. Exemplary formats include Sony LANC #1, #2 (also referred to as Control-L); Panasonic Control-M #1, #2; RS-422/232 #1, #2; and Universal IR Transmitter. The Universal IR Transmitter format includes both an IR transmitter mounted directly on the front of the base unit and a wired IR transmitter pendant that can be attached to the face of the IR receiver.

As noted above, the I/O port 34 may be a USB port, which can be controlled by a USB host controller. In one embodiment, the USB controller has four ports, only two of which are provided with external connectors. In one embodiment, the internal ports are assigned to the flash media reader 36 and to a receiver for the Gyration input device 16. A Transdimension/SoftConnex USBlink protocol stack can be used for support of this interface. Additional I/O ports may also be provided for connecting to a host computer, for connecting to pointing devices or for connecting to external storage devices.

Referring now to FIG. 2, a functional description of the video processing of the dedicated logic circuit 22 is described. In one embodiment, the dedicated logic circuit 22 processes images containing up to two million pixels at refresh rates up to 75 Hz. The dedicated logic circuit 22 receives multiple video input streams. Within the dedicated logic circuit 22, a live video multiplexer 40 selects one of the live video inputs in response to a user command. The selected signal is either stored in an image buffer 280 or forwarded directly to alpha blender logic 42 within the dedicated logic circuit 22. The video is initially live video. When the video is paused or rewound, the last frame is buffered and the stored video is used.

There are two other image buffers 282, 284 that are writable by the CPU 30: an overlay buffer 284 that contains full-color graphics, and an 8-bit alpha buffer 282 that controls how the two primary inputs to the alpha blender 42 are combined on a pixel-by-pixel basis.

Alpha blending is a general technique for mixing two images together based on a value in a third image plane, or “alpha” plane. A pixel (X, Y) in the output image is calculated by the alpha blender 42. That is, the alpha blender 42 combines its image input and its overlay input pixel-by-pixel in real time according to the following equation:
Result [x, y]=(1−alpha [x, y])×Image [x, y]+alpha [x, y]×Graphics [x, y]

When the alpha value is zero, the output is the same as the image. When the alpha value is one, the output is the same as the overlay. Intermediate values of alpha cause the two buffers to be blended to varying degrees. For example, if the overlay buffer is filled with black, a “spotlight” effect can be created by filling the alpha buffer with, e.g., 0.2 and then drawing an ellipse containing 0.0 in the alpha buffer. The output image will be full brightness where the ellipse is located in the alpha buffer, while the rest of the image will be darkened slightly. One possible variation is to change the alpha value gradually from one value to the other at the edges of the oval, giving the spotlight a fuzzy boundary instead of a sharp edge.

Overlaid graphics are generated by filling the alpha buffer with zero, then drawing the graphics in the desired patterns while simultaneously setting the alpha value to 1.0 where the graphics are located. This creates opaque graphics that hide the underlying image. Translucent graphics can be created by using an alpha value of less than one.

The image input to the alpha blender 42 can come from the image buffer memory 280, or it can come directly from the live video input. The live video input can be written to the image buffer 280 for subsequent transfer by the CPU 30 to main memory 35 or external flash memory 36, e.g., saved as ajpeg image. The CPU 30 can also write stored images back into the image buffer 280 for subsequent playback, for example when telestrating over a slide show comprised of jpeg, bitmap, and other image files.

The snapshot feature is used to save an image file, e.g. a jpeg, of the current screen. Because internal memory has a limited amount of space for snapshots, this function can be configured to save to flash media 36. If saved to the flash media 36, a default directory can be created to save to. Filenames can be generated by the software in an incremental format.

In one embodiment, the video buffer 28 used by the dedicated logic circuit 22 is a bank of external DDR SDRAM. Preferably, enough memory is provided so that there is sufficient space for multiple copies of each type of buffer (image buffer 280, alpha buffer 282, overlay buffer 284). Each buffer 28 should have enough memory to provide multiple buffers of each kind, allowing for smooth animation and decoupling the CPU timing from that of the video stream. In one embodiment, at least 64 MB of video memory is provided for the storage of images and graphics.

Individual frame buffers require varying amounts of this memory depending on the current video format. Broadcast video with a pixel rate of 13.5 MHZ and a frame rate of 30 Hz requires 450,000 words (1.8 MB) of buffer memory. Broadcast video with a pixel rate of 13.5 MHZ and a frame rate of 25 Hz requires 540,000 words (2.16 MB) of buffer memory. VGA video with 800×600 resolution requires 480,000 words (1.92 MB) of buffer memory. HDTV with 1920×1080 resolution requires 2,073,600 words (8 MB) of buffer memory.

In one embodiment, the video memory 28 has a total bandwidth of roughly 800 Mbps, supporting simultaneous processing by the dedicated logic circuit 22 of up to two streams of frame buffer data (one writing and one reading, or two reading). One digital video stream at standard resolution represents 54 Mbps of data, resulting in a total bandwidth of 108 Mbps. HDTV and SVGA at 1280×1024 resolution can require up to about 400 Mbps per stream.

The main memory 35 can include up to 256 MB of 100 MHZ SDRAM. Two types of flash EEPROM are provided: 8 MB of directly-addressable NOR flash is provided for bootstrapping the firmware. Up to 256 MB of serial-access NAND flash EEPROM is provided for application firmware and associated data files.

The dedicated logic circuit 22 sits on the processor's memory bus as a memory-mapped device, and is controlled by the main processor 30 via its bus interface. An interrupt output provides real-time synchronization between the video hardware 10 and the application software 32.

The dedicated logic circuit 22 connects the video input decoder 24 and the video output encoder 26 to the processor system 30 providing access to the video buffers 28 and the internal control registers of the dedicated logic circuit 22. As noted above, the video frame buffers 28 are separate from the CPU's main memory 35. This separation supports the higher data rates required by HDTV and high-resolution VGA formats.

The dedicated logic circuit 22 provides several key real-time video processing functions: Direct video pass-through; Write video input data to frame buffer (one-shot or continuous); Read video output data from frame buffer; Alpha-blend frame buffer data with direct video input; and Alpha-blend data from two separate frame buffers.

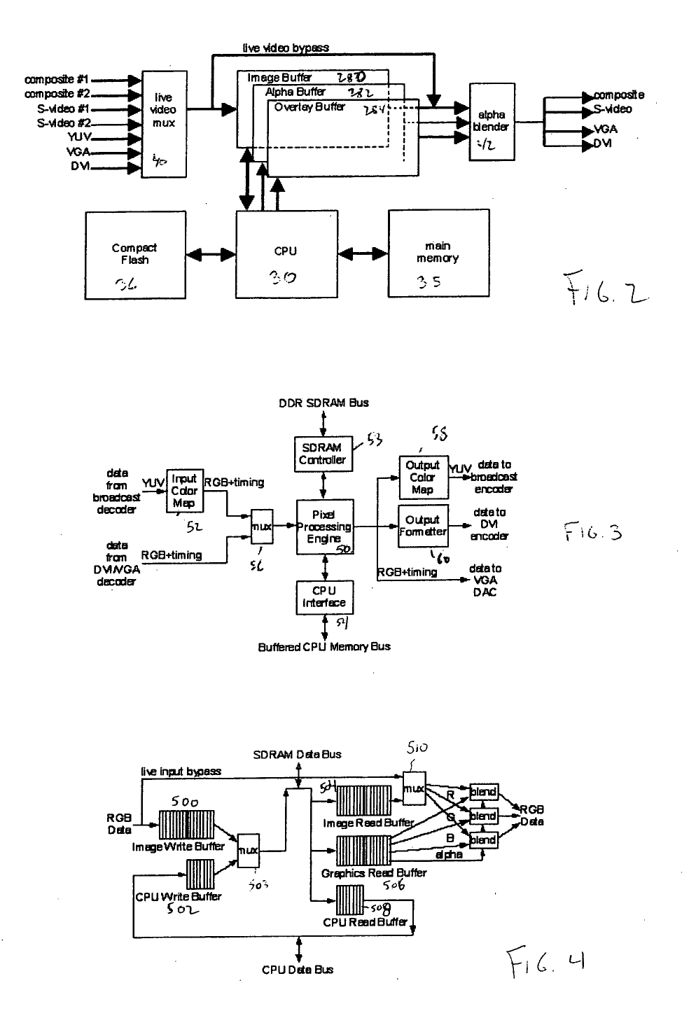

Description of an exemplary dedicated logic circuit 22 will now be provided with reference to FIG. 3. The dedicated logic circuit 22 handles all of the real time video processing. Within the dedicated logic circuit 22, a controller 53 is provided to control a bank of external SDRAM 28 that stores video images and graphics. The dedicated logic circuit 22 also includes an interface 54 to the host CPU 30 to allow software 32 to manipulate the buffer contents.

Internally, the dedicated logic circuit 22 incorporates the functionality shown in FIG. 3. The broadcast video decoder 24 outputs data in interleaved YUV format, while the DVI/VGA decoder 24 provides data as separate R, G, and B channels. The YUV data is converted to RGB with reference to an input color map 52, and all images and graphics are stored in RGB format. In one embodiment, the input color map 52 performs a 3×3 matrix multiplication. All input streams enter a multiplexer 56, which selects one of the input streams for processing.

A pixel processing engine 50 receives the RGB data and either stores it into the video buffer 28 or passes it through while combining it with graphics generated by the CPU 30. The output timing of the engine 20 is always identical to the input timing. Thus, each input signal is decoded into an RGB signal and a timing signal.

The final RGB data produced by the engine 20 is passed to the output encoder chips 26 in the expected data format. The broadcast encoder 26 requires interleaved YUV data, so another color conversion is performed using an output color map 58, similar to the input conversion performed by the input color map 52. The DVI encoder 26 requires RGB data that is interleaved onto a narrow bus. An output formatter 60 interleaves data for the DVI encoder 26. The VGA DAC 26 accepts separate R, G, and B channels.

The hardware/software interface 54 between the host CPU 30 and the dedicated logic circuit 22 consists of a set of memory-mapped registers allocated at the high end of the memory segment assigned to the dedicated logic circuit 22. These registers include an image write start address, which can be a 24-bit word address of the first pixel to write in the next frame. The registers also include an image read start address, which can be a 24-bit word address of the first pixel to read in the next frame. Another register is a graphics read start address, which can be a 24-bit word address of the first pixel to read in the next frame. Several other registers store the total pixels per line, the number of clock pulses counted between horizontal sync events, which could be eleven bits, and the active pixels per line, which is also measured. Additional registers include eleven bits for the number of clock pulses counted in the active picture area, the measured total lines per frame, eleven bits for the number of lines counted between vertical sync events, the measured active lines for each frame, eleven bits for the number of lines counted in the active picture area, the generated total pixels for each line, and eleven bits for the number of clock pulses between horizontal sync events. Still other registers store the generated active pixels per line, eleven bits for the number of clock pulses in the active picture area, the generated total lines for each frame, eleven bits for the number of lines between vertical sync events, the generated number of active lines for each frame, and eleven bits for the number of lines in the active picture area.

A CPU data buffer (e.g., eight words) may also be provided, as can eight 32-bit registers for containing the data for burst writes to video memory or burst reads from video memory.

A register for the 24-bit word address of the next burst transfer to/from the CPU data buffer is also provided. The burst memory operation is initiated by writing to this register.

A video path controls register contains individual bits that configure the various elements of the video data path, including multiplexer controls, color map enables and read/write enables.

An interrupt enables register contains individual bits that enable various interrupt sources within the dedicated logic circuit 22, including end of frame, end of line, first active line, first active pixel and burst transfer complete.

An interrupt status register contains status flags corresponding to the individual interrupt sources listed above. In addition, the host CPU 30 can directly read and write individual words in the video buffer memory.

FIG. 4 shows the pixel processing engine 50 in more detail. The pixel processing engine 50 includes two write buffers, one buffer 500 for real-time image data and one buffer 502 for data from the CPU 30. A multiplexer 503 selects data to be written to the external RAM 28. The sources being selected from are the live video input and the CPU 30.

There are three read buffers: one buffer 504 for image data, one buffer 506 for graphics data, and one buffer 508 for data requested by the CPU 30. The CPU buffer 508 is primarily for the snapshot feature, i.e., storing a telestrated image to an external memory, such as a flash media 36. The CPU buffer 508 also allows the CPU 30 to read back any other data it might have written to the CPU buffer 508, e.g., for read-modify-write operations on the graphics buffer 506.

Generally speaking, data is transferred to or from the external SDRAM 28 in bursts of eight 32-bit words. In one embodiment, the real-time video data (input, output and graphics) is double-buffered, so there are sixteen words of on-chip storage for each of these paths. The CPU read and write buffers 502, 508 may be single-buffered, having only eight words of storage in each of these paths.

A multiplexer 510 selects the video to be displayed underneath the telestration. The multiplexer 510 selects between live video or still images read from the image read buffer 504. The buffers may be hardware buffers, i.e., pipeline registers within the dedicated logic circuit 22. They are used to adapt the video timing to the external buffer's timing.

Image data is stored one pixel per 32-bit word, with eight bits allocated to each of the red, green, and blue components of the video. The remaining eight bits are used in the graphics buffer to contain the alpha value that controls the blending of the output images.

The image data (either live or stored) is alpha blended with the graphics data. The corresponding color components from each side are combined according to the alpha parameter, which is generated by the CPU 30 and stored in the graphics buffer 506.

A description of the application 32, which runs with a real time operating system 35, such as the Windows CE Operating System, and several device drivers, is now provided. The software 32 provides a unique way to annotate live video signals in order to enhance presentations. With the software, the user is able to control the playback functions of the video equipment or computer and draw graphics (such as lines, circles, squares, stamped objects or words, and numbered circles) over the video output.

In addition to video input from external equipment, the software also supports a slide show mode using graphic files read from flash media 36 inserted into a universal flash media reader connected to the USB port 34. The application 32 also is designed to be a device controller in a number of control protocols, such as RS-422, RS-232, Control-M, LANC, and Universal IR.

The processor 30 enables video transport control. If the PXA25x is used, it includes three on-chip UARTs with varying capabilities that are allocated to the wired video transport controls (LANC, Control-M and RS-232/422). A special purpose integrated circuit, e.g., a programmable interrupt controller (PIC) may control the output protocol of the Control-M and LANC ports. The Intel chip also includes an on-chip Synchronous Serial Port (SSP) that generates the IR output signal for transport control in accordance with the Universal IR Remote format.

The software 32 includes several modules, enabling a video telestration mode, a chalkboard mode, and a slide show mode. The video telestration mode has two main features, device control and drawing or “telestration.” In drawing mode the input video source is passed through to the outputs. Assigned buttons on the input device 16 control basic remote control functions, such as Play, Stop, Pause, Fast Forward, Rewind, etc. A suite of telestration tools is provided for creating graphics over the output video.

The chalkboard mode functions similarly to the video telestration mode with the exception that the chalkboard mode uses solid colors or bitmap files as the background instead of incoming video. The application 32 incorporates a number of bitmap files that can be stored internally and additional bitmap files can be uploaded by the user. Because the purpose of the chalkboard mode is telestration without video, most of the control buttons are disabled in this mode.

The slide show mode is a utility that allows access to graphics files, such as jpeg, bmp, tif, gif PowerPoint Presentations, Adobe Acrobat PDF, etc, from flash media, for creating slide show sequences, and viewing the files as the background for telestration. The functions of certain remote buttons will change in this mode to accommodate advancing to the next or previous slide. The slide show software can be offered in a PC installable version allowing the user to create and save slide shows to flash media in advance on a computer, then transport the flash media card to the application 32.

The sequence of events occurring after the video processing unit 10 is powered on is now described. Initially, the device 10 is powered on launching a power on self test. The selftest initializes the hardware onboard and checks integrity of memory, CPU, etc. If there are errors, in one embodiment a Conflict LED on the front of the box 10 will inform the user of the problem with flash codes. For example, two flashes indicates a memory problem, three flashes indicates a CPU problem, etc. After the self test is successful, the operating system loads. The state of a dip switch is then checked to determine the language the software displays, e.g., German, French, Spanish, etc., and the format of the video encoder/decoder chips, e.g., NTSC, PAL, or SECAM.

Next, drivers are loaded for all devices on the board. In one embodiment, the devices include an Intel XScale PXA255 CPU, a Philips SAA7118E video decoder, a Philips SAA7129H video encoder, an Analog Devices AD9882 VGA/DVI decoder, a Chrontel CH7010A component video/DVI encoder, an Analog Devices ADV7125 digital to analog converter, and a Transdimension UHC124 USB host controller. Other drivers to be loaded include driver software for RS-232/RS-422 video transport control, driver software for LANC/Control-M video transport control, driver software for IR video transport control, and driver software for USB mass storage devices, card reader, wireless hub, etc.

Next, the USB port is checked for qualified devices such as graphics tablets, flash driver software, USB Gyration receiver (and other pointing devices), etc. After the drivers have been loaded, the device 10 detects the type of user input device 16.

If a PDA is being used, the wireless hub must be detected and initialized, communications established between the PDA and the wireless hub, and client software launched on the PDA itself. If a graphics tablet is being used, it should be detected and automatically initialized by the operating system 35. If auto detection is not employed available dip switches can be set for the appropriate user input devices.

Welcome Screens are then displayed to generate video on all outputs so that a user can have a starting place to begin working. Once the application 32 has been launched, the user is guided towards the Telestration mode. After receiving the user's selections, the Telestration mode begins and the selected video source will be displayed.

In one embodiment, Video Telestration Mode is largely invisible on screen. The only visible indication will be the cursor itself. There will be several cursors to choose from in the user preferences. In different situations, the cursor will change shape or display a pop up screen tip.

Most of the functions will be available readily on the input device 16. Other less used functions will be better utilized through a pop up toolbar method. In the screen corners and in the middle of each edge of the screen a hidden zone exists. When the cursor moves over the hidden zone for a period of time, e.g., for one second, a toolbar appears. As the cursor moves over each icon on a toolbar, a pop up description indicating its function appears. When the cursor moves off the hidden zone or the hidden zone is selected, e.g., clicked upon, the icon or pop up disappears from the screen.

As noted above, the video processor 10 supports more than one device plugged into it. A user command allows the user to change which input channel to monitor. Upon receiving the command, the software 32 sends a command to the input decoders 24 to switch inputs. In addition to changing the video input channel, the software 32 changes the control port and protocol type configuration depending on which device is plugged into which port.

Many drawing and graphics functions are available. For example, the trigger on the Gyro remote activates the motion sensor to move the cursor. When the trigger is not held down and no cursor movement is detected the cursor can be hidden. This will make the input device 16 feel a bit like a laser pointer. Each time the trigger is pressed and cursor movement is detected, the cursor reappears on the screen in its last position. Several options exist for drawing tool selection, including toolbar, gestures, and remote buttons. For example, using the remote 16, holding the trigger and then pressing the right mouse button will cause display of a box momentarily showing the current assignment. Double clicking the right mouse anywhere on the screen opens a toolbar to select a drawing tool.

Many telestration tools are also provided. A Freeform tool creates points along a line path and smoothes out the curves of the line. The tool resets after a draw button (e.g., holding the trigger and pressing the left mouse button) is released and the line becomes selectable. The handles on the line can be grabbed and moved. It can also be selectively deleted with an undo button or the Clear button on the remote.

A Curve tool draws a straight line and then allows the user to grab the line anywhere on the line and bend it into a curve. The ability to select the line again to adjust the curve is also provided. It is different from freeform in the aspect of having a single handle to create the curve.

A Point-to-Point tool draws straight lines between mouse click points. The first click leaves a dot, and subsequent clicks draw straight lines between points. Double clicking the left mouse button resets the tool. After the tool has been reset, if the cursor is moved over one of the line segments and the button is held, the user can bend and pull the line segment like the Curve tool. The user can also select the connect points and move them.

An Ellipse tool is used to draw an ellipse from the corners. A Solid Ellipse tool is like the Ellipse tool except the created ellipse is filled with a solid color. A Rectangle tool is used to draw a rectangle from the corners c. A Solid Rectangle tool is like the Rectangle tool only the created rectangle is filled with a solid color.

An Ellipse+Freeform tool enables a user to draw a circle around something, and then switch to a line drawing tool to indicate the circled object's movement. This tool has two actions. The first action behaves like the Ellipse tool. When the button has been released it switches automatically to the Freeform tool. The Freeform line automatically snaps to the closest place on the ellipse, when the beginning point of the line is within a certain short distance. Any part of the graphic elements, ellipse or lines, can be selected by clicking the cursor on top of the lines.

An Ellipse+Point-to-Point tool enables a user to draw a circle around something, and then switch to a line drawing tool to indicate the circled object's movement. This tool has two actions. The first action behaves like the Ellipse tool. When the button has been released it switches automatically to the Point-to-Point tool. The Point-to-Point line automatically snaps to the closest place on the ellipse, when the beginning point of the line is within a certain short distance. Any part of the graphic elements, ellipse or lines, can be selected by clicking the cursor on top of the lines.

An Ellipse+Curve tool enables a user to draw a circle around something, and then switch to a line drawing tool to indicate the circled object's movement. This tool has two actions. The first action behaves like the Ellipse tool. When the button has been released it switches automatically to the Curve tool. The Curve line automatically snaps to the closest place on the ellipse, when the beginning point of the line is within a certain short distance. Any part of the graphic elements, ellipse or lines, can be selected by clicking the cursor on top of the lines.

A Rectangle+Freeform tool enables a user to draw a rectangle around something, and then switch to a line drawing tool to indicate the encircled object's movement. This tool has two actions. The first action behaves like the Rectangle tool. When the button has been released it switches automatically to the Freeform tool. The Freeform line automatically snaps to the closest place on the rectangle, when the beginning point of the line is within a certain short distance. Any part of the graphic elements, rectangle or lines, can be selected by clicking the cursor on top of the lines.

A Rectangle+Point-to-Point tool enables a user to draw a rectangle around something, and then switch to a line drawing tool to indicate the encircled object's movement. This tool has two actions. The first action behaves like the Rectangle tool. When the button has been released it switches automatically to the Point-to-Point tool. The Point-to-Point line automatically snaps to the closest place on the rectangle, when the beginning point of the line is within a certain short distance. Any part of the graphic elements, rectangle or lines, can be selected by clicking the cursor on top of the lines.

A Rectangle+Curve tool enables a user to draw a rectangle around something, and then switch to a line drawing tool to indicate the encircled object's movement. This tool has two actions. The first action behaves like the Rectangle tool. When the button has been released it switches automatically to the Curve tool. The Curve line automatically snaps to the closest place on the rectangle, when the beginning point of the line is within a certain short distance. Any part of the graphic elements, rectangle or lines, can be selected by clicking the cursor on top of the lines.

A Point Numbering tool places a small circle with the number 1 in the center of it at the point the cursor is clicked. Subsequent cursor clicks creates the small circled numbers with ascending numeric values, i.e., 2, 3, 4, etc.

A Spotlight tool “dims” the screen and the cursor essentially becomes an elliptical “hole.” In one embodiment, to change the size and shape of the ellipse, the user presses the left mouse button and makes the change. As long as this tool is selected, the trigger activates Spotlight mode and the last size and shape of the spotlight is remembered. Also in this mode the right mouse button can be an active Play/Pause button, because motion video will often be spotlighted.

A Text Stamping tool paints a word anywhere on the screen the left mouse button is clicked. When the Text Stamp tool is active, the left side of the screen is a “” vertical pop up toolbar that displays a list of previously created words and an icon to open an on screen keyboard for the purpose of creating text for the Text Stamp tool. A limited number of words can be stored. The cursor for this tool will change to indicate Text Stamping mode.

A Clipart Stamping tool paints clipart anywhere on the screen the left mouse button is clicked. When the Clipart Stamp tool is active, the left side of the screen is a “” vertical pop up toolbar that displays a list of available clipart and an icon to browse available storage for clipart files, such as flash media or internal storage. There will be a limited amount of clipart that can be stored internally. The cursor for this tool will change to indicate Clipart Stamping mode.

A Black and White tool removes the color information from the video. Sometimes the chroma channel can be too much information. A quick switch to black and white can help to better analyze the video.

A Clock Toolbar icon or Zone Icon opens a form to create a clock or countdown timer with a custom message. Let's say you are giving a lecture and you want to take a fifteen-minute break. You could select TIMER and the message “Be back in: 15:00.”

A Stop Watch feature lets the user time something that is happening on video. For example in football, coaches are interested in how long a kicked ball is in the air, or “hang time.” The Stop Watch feature can be opened using a hotspot in the lower left corner of the screen. The feature has a digital display, Start, Lap, Stop, and Close. Each time the LAP is used, an extra clock display is added. In one embodiment, the cursor is locked over the area of the Stopwatch bar when active rather than centered each time the trigger is used.

A Slide Show mode uses graphics files, such as jpeg, bmp, tif, etc. to a create a slide show presentation and to use the slide show as the background over which telestration occurs. Deck control controls will be disabled in Slide Show mode and the remote buttons will change function. The Presentation GUI is largely icon driven with the left and right mouse buttons. During a slide show the remote buttons change some of their functions.

A Save Snapshot feature enables a user to save a current picture with graphics to the same location as the original file with an addendum to the filename (such as of −001) for example “Picture of car crash −001.jpg”. In the event there is no more disk space, an option to browse different available media is presented.

During a slide show presentation, all normal telestration tools, toolbars, etc. remain in effect. If a different input source is selected, the system will remember the slide show “in progress” as an “input channel” and allow the user to go back and forth between other channels and the slide show. The user can clear any slide's graphics any time they wish by using a clear screen function.

Chalkboard mode is essentially video telestration mode only it replaces the video background with a solid color or background bitmap file.

Animation is a feature that allows the user to create graphics that move. This would be very useful for example in a court room describing an auto accident. A diagram is drawn showing the various elements of the scene. The Animate console is opened and additional “sequences” are added with the Add Sequence icon. This essentially saves a copy of the current set of graphics as sequence 1, then allows the user to manipulate them into different positions and save the other sequences as secondary sequences. Numerous “sequences” can be added and then played back at varied speeds. Playback displays smooth movement of the graphics between each sequence into their different positions plus any new graphics added to a particular sequence.

Thus, the application 32 has two main functions, telestration and device control. Telestration is defined as drawing or creating graphics that interact with a background layer of motion video, still pictures from video or graphics files such as jpegs, bitmaps, or solid colors.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium, e.g., a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards represent examples of the state of the art. Such standards are periodically superseded by faster or more efficient equivalents having essentially the same functions. Accordingly, replacement standards and protocols having the same functions are considered equivalents.

1. A real time embedded video processing system, comprising:
a real time operating system;
a graphics application that generates computer graphics in response to user input;
an input control application that controls at least one of video input source in response to user input; and
a video processing engine that receives input from at least one of the video input sources and receives computer graphics from the graphics application, the video processing engine blending the computer graphics with the input and outputting the blended data in substantially real time.

2. The system of claim 1, further comprising an input/output (I/O) interface that communicates with a user input device.

3. The system of claim 2, in which the I/O interface communicates with a mass storage device.

4. The system of claim 3, in which the video processing engine receives input from the mass storage device and overlays the computer graphics on the input received from the mass storage device in real time.

5. The system of claim 2, in which the I/O interface is a USB interface.

6. The system of claim 1, in which the video processing engine comprises a dedicated logic circuit, at least one encoder, at least one video decoder, and a video buffer.

7. The system of claim 6, in which the dedicated logic circuit comprises a field programmable gate array (FPGA)

8. The system of claim 1, in which the plurality of video input sources have a plurality of different control protocols.

9. The system of claim 8, in which the protocols comprise at least one of RS-232, RS-422, Control-M, LANC, and infrared.

10. The system of claim 1, in which the plurality of video input sources generate video streams having a plurality of different formats.

11. The system of claim 10, in which the different formats comprise at least one of YUV, RGB, S-Video, composite, VGA, and DVI.

12. The system of claim 11, in which the system translates video from one of the formats to another of the formats.

13. The system of claim 10, in which one of the video streams is in a YUV format, and the video processing engine digitally color maps the YUV format into an RGB format.

14. The system of claim 1, in which the video processing engine outputs the blended data to a plurality of output devices.

15. The system of claim 1, in which the user input device comprises a PDA comprising a client application that communicates with a host application within the system.

16. The system of claim 1, in which the blended data is stored as an image file.

17. The system of claim 1, in which the system is portable.

18. A dedicated logic circuit for real time video processing, comprising:
a pixel processing engine that receives input from a video input source and receives computer graphics from a graphics application, the pixel processing engine alpha blending the computer graphics with the video input source and outputting the blended data in substantially real time.

19. The dedicated logic circuit of claim 18, further comprising a buffer controller that controls an external buffer, and a CPU interface that receives the computer graphics.

20. The dedicated logic circuit of claim 18, in which the dedicated logic circuit processes a plurality of input video streams and outputs a plurality of output video streams, the streams having a plurality of different formats.

21. A real time embedded video processing system, comprising:
a central processing unit (CPU);
a real time operating system that communicates with the CPU;
an input/output (I/O) interface that receives user input via a wireless user input device;
a graphics application that generates computer graphics in response to user input received from the user input device, the application interfacing with the CPU via the operating system;
a device remote control application that controls a plurality of different video input devices in response to user input received from the user input device; and
a video processing engine comprising a field programmable gate array (FPGA), a video buffer, at least one video decoder, and at least one video encoder, the FPGA comprising a CPU interface, a video buffer controller, and a pixel processing engine that receives input from at least one of the video input sources via at least one of the video decoders and receives computer graphics from the graphics application via the CPU and the CPU interface, the pixel processing engine alpha blending the computer graphics with the input and outputting the blended data in real time to at least one of the video encoders.

22. The system of claim 20, in which the system is portable.
